(19) United States
(12) Patent Application Publication
(10) Pub. No.: US 2025/0045578 A1
(43) Pub. Date: Feb. 6, 2025

(54) METHOD FOR TRAINING A MACHINE LEARNING MODEL

(71) Applicants: ROBERT BOSCH GmbH, Stuttgart (DE); CARIAD SE, Wolfsburg (DE)

(72) Inventors: Lukas Schott, Stuttgart (DE); Jan Mathias Koehler, Leonberg (DE); Claudia Blaiotta, Stuttgart (DE)

(21) Appl. No.: 18/774,344

(22) Filed: Jul. 16, 2024

(30) Foreign Application Priority Data
Aug. 3, 2023 (DE) 10 2023 120 619.2

(51) Int. Cl. G06N 3/08

(52) U.S. Cl. CPC G06N 3/08

(57) ABSTRACT

The invention relates to a method (100) for training a machine learning model for application for a machine, comprising the following training steps:
providing (101) training data, the training data being specific for the application of the machine learning model,
initiating (102) processing of the training data, in which multiple tasks are processed by the machine learning model concurrently,
determining (103) losses for the individual tasks, the particular loss being based on a difference between the output generated by the machine learning model and a default,
weighting (104) the determined losses, the weighting being carried out using at least one task-specific uncertainty based on an analytical computation,
updating (105) weights of the machine learning model, based on the weighted losses, for the training of the machine learning model.

The invention relates to a method for training a machine learning model. The invention further relates to a machine learning model, a computer program, a device, and a memory medium for this purpose.

### PRIOR ART

When multiple tasks (for example, semantic segmentation, object recognition, classification, and the like) are simultaneously processed in a neural network, this is referred to as multitasking. In most cases, all tasks share a portion of the network (referred to as the “backbone”), and each task obtains its own layers (referred to as “heads”).

In order to train a multitasking-network, the various losses of the individual tasks must be combined into an overall loss. The exact weighting of the task-specific losses is critical for ensuring a desired distribution of the capacity within the neural network.

### DISCLOSURE OF THE INVENTION

The subject matter of the invention relates to a method having the features of claim 1, a machine learning model having the features of claim 7, a computer program having the features of claim 8, a device having the features of claim 9, and a computer-readable memory medium having the features of claim 10. Further features and details of the invention result from the respective subclaims, the description, and the drawings. Of course, features and details that are described in conjunction with the method according to the present invention also apply in conjunction with the machine learning model according to the invention, the computer program according to the invention, the device according to the invention, and the computer-readable memory medium according to the invention, and vice versa in each case, so that with regard to the disclosure, mutual reference is or may always be made to the individual aspects of the invention.

The subject matter of the invention relates in particular to a method for training a machine learning model for application for a machine, for example for object recognition in autonomous driving. The method comprises at least a portion of the following training steps:
providing training data, the training data being specific for the application of the machine learning model,
initiating processing of the training data, in which multiple tasks are processed by the machine learning model concurrently,
determining losses for the individual tasks, the particular loss being based on a difference between the output generated by the machine learning model and a default (where the default may be predefined) in order to provide a reference for the application of the machine learning model, for example in the form of a ground truth,
weighting the determined losses, it being possible for the weighting to be carried out using at least one task-specific uncertainty based on an analytical computation, preferably an optimum computation and in particular an analytical computation of the optimum, in particular in order to compensate for the tasks in different scales,
updating weights of the machine learning model, based on the weighted losses, for the training of the machine learning model.

In the method according to the invention, it may be provided that the various losses, such as classification losses and regression losses, are simultaneously learned using a multitask loss. This serves the particular purpose that different quantities and units may be used. At least one task-specific, i.e., in particular task-dependent, uncertainty may be used which may reflect the relative confidence between the tasks and may be a function of the representation or the unit of the task. Determining the particular loss and/or the weighting of the determined losses may be carried out based on at least one loss function. The loss function, preferably a multitask loss function that is used for the multitask loss, may be based on maximizing a Gaussian probability with homoscedastic uncertainty.

It is possible to utilize task-specific uncertainties in order to compensate for tasks in different scales. For example, one task may be measured in millimeters and another task may be measured in meters, which may result in drastically different loss weightings which must be compensated for. Initialization of the task weights is not always sufficient using conventional methods. While known approaches concentrate primarily on computing the task weights during the training, according to the invention a main focus may in particular be on their initialization. Complex multitask systems include numerous different tasks. It has been found that a well distributed initialization of the task weights in complex multitask systems is of crucial importance. Neural networks are often trained using backpropagation based on gradient descent methods, which generally adapt only slowly. Therefore, large discrepancies in the loss weights are often not compensated for when the starting value is too far away. This may result in divergences and slow learning processes. The problem is also becoming more important for multitask learning environments with multiple tasks (more than three, for example) or very different tasks (for example, not only different classification tasks, but also object recognition and segmentation). Thus, in environments such as autonomous driving, for example, various tasks such as pedestrian recognition, vehicle recognition, and roadway recognition are often needed in various formats such as classification, bounding box, segmentation, and/or spline fitting.

It is also advantageous when, within the scope of the invention, the step of updating the weights of the machine learning model is carried out initially at a start of the training and/or (subsequently) iteratively during the training, in each case based on the analytical optimum computation. Alternatively or additionally, the losses may initially be weighted differently (i.e., not in a constant manner), and an initialization of the weighting of loss functions for the losses for the various tasks and in particular an initialization of task weights may take place differently. The invention may have the advantage that large discrepancies between the tasks may be compensated for within the first pair of iterations of the training. It has been shown that this may result in more stable training (relying solely on previous methods may lead to divergences), faster convergence (and thus a reduction in computing costs), and improved overall performance across all tasks. A correct initialization for the uncertainty weights may be a critical component in the training pipeline.

It may optionally be provided that the losses for each of the tasks are determined based on a task-specific loss function, which is preferably based on a distribution of a location-scale family and/or approximations and/or a maximization of a Gaussian probability with homoscedastic uncertainty. The location-scale family may encompass a family of probability distributions that are parameterized by a location parameter and a non-negative scale parameter. In addition, the task-specific uncertainty may be determined based on the loss that is determined for the particular task. Furthermore, it is possible for a representation or unit of the tasks to differ, and for the task-specific uncertainty to be a function of the representation or unit. Moreover, it is conceivable for the step of weighting the determined losses to be carried out based on the analytical optimum computation and/or the loss function of a present and/or previous iteration of the training steps. For regression tasks, the probability may be defined as a Gaussian distribution with an average value that is provided by the model output. For classification tasks, the model output may be processed by a softmax function, and a sample may be taken from the resulting probability vector. In this way, the uncertainty terms may decrease during the training, which improves the optimization process.

It is possible for the analytical optimum computation, in particular of a loss weight of a present iteration, to be additionally stabilized with the loss weights of multiple previous iterations of the training steps, preferably by means of a running average. Furthermore, it is conceivable for the analytical optimum computation to include a computation of a running average over loss weights of a present iteration and multiple previous iterations of the training steps. A more reliable training of the machine learning model may thus be possible.

A further advantage within the scope of the invention is achievable when the machine learning model is designed as an artificial neural multitasking network in order to concurrently process the multiple tasks for assisting with operation of the machine, preferably for providing autonomous driving. More complex tasks for the operation of the machine may thus be processed.

Furthermore, it is optionally provided that the training data are specific for collected sensor data from at least one sensor, preferably a camera sensor, of the machine, preferably a vehicle or robot. The machine learning model may be trained for the application for autonomous driving and/or autonomous navigation, in particular for pedestrian recognition and/or vehicle recognition and/or roadway recognition. In many cases, a single neural network may be required for simultaneously solving multiple tasks, sharing knowledge between the tasks, and increasing the computing efficiency. Thus, for autonomous driving, for example, lanes, pedestrians, vehicles, drivable surfaces, etc., may be assessed.

Moreover, it is possible for the tasks to encompass semantic segmentation and/or object recognition and/or classification, which are preferably represented differently and/or include different units, wherein the representation and/or the units may result in a different scale for the loss function.

In addition, the machine may also be designed as a tool or the like. For example, for an intelligent drill, it may be necessary for the type of material and the depth of the drill bit to be assessed at the same time. It is also possible for the machine to be designed as a surveillance camera. For surveillance cameras, the recognition of pedestrians, potentially hazardous situations, and other tasks of interest may be derived simultaneously.

The subject matter of the invention further relates to a machine learning model for assisting with operation of a machine via the processing of multiple tasks for the machine, in particular trained by a method according to the invention. The machine learning model according to the invention thus provides the same advantages as described in detail with regard to a method according to the invention.

The subject matter of the invention further relates to a computer program, in particular a computer program product, that includes commands which, when the computer program is executed by a computer, prompt the computer to carry out the method according to the invention. The computer program according to the invention thus provides the same advantages as described in detail with regard to a method according to the invention.

The subject matter of the invention further relates to a device for data processing which is configured to carry out the method according to the invention. For example, a computer that executes the computer program according to the invention may be provided as the device. The computer may have at least one processor for executing the computer program. In addition, a nonvolatile data memory may be provided in which the computer program is stored, and from which the computer program may be read out by the processor for the execution.

The subject matter of the invention may further relate to a computer-readable memory medium that includes the computer program and/or commands which, when executed by a computer, prompt the computer to carry out the method according to the invention. The memory medium is designed, for example, as a data memory such as a hard disk and/or a nonvolatile memory and/or a memory card. The memory medium may, for example, be integrated into the computer.

Moreover, the method according to the invention may be also be designed as a computer-implemented method.

Further advantages, features, and particulars of the invention result from the following description, in which exemplary embodiments of the invention are described in detail with reference to the drawings. The features mentioned in the claims and in the description may be essential to the invention, individually or in any given combination. In the drawings:

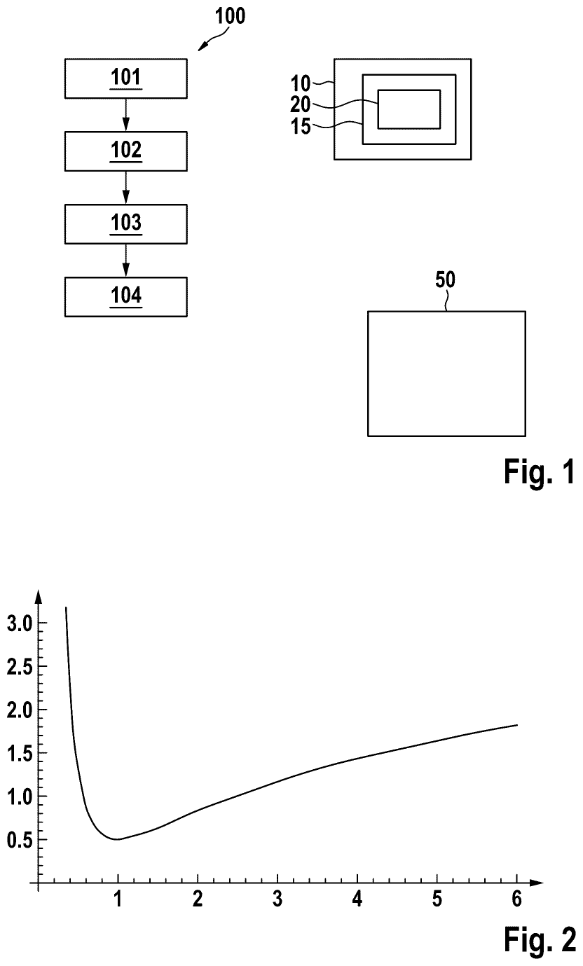

FIG. 1 shows a schematic visualization of a method, of a device, of a memory medium, and of a computer program according to exemplary embodiments of the invention.

FIG. 2 shows an example of a result of an equation for compensating for multiple tasks.

A method 100, a device 10, a memory medium 15, and a computer program 20 are schematically illustrated in FIG. 1 according to exemplary embodiments of the invention. Also shown is a machine learning model 50 according to exemplary embodiments of the invention.

FIG. 1 illustrates the method 100, which may be used for training a machine learning model 50 for application for a machine. The provision of training data initially takes place according to a first training step 101. The training data may be specific for the application of the machine learning model 50. This may mean that the training data include inputs of the type that are also processed in the subsequent application by the machine learning model. The training data may also include a default, i.e., in particular a reference that indicates which output of the machine learning model 50 is expected from the processing.

Initiation of processing of the training data, in which multiple tasks are concurrently processed by the machine learning model, may subsequently [take place] according to a second training step 102. Losses may then be determined according to a third training step 103. The losses are determined specifically for the individual tasks, wherein the particular loss may be based on a difference between the output generated by the learning model 50 and a default. Weighting of the determined losses may subsequently take place according to a fourth training step 104, wherein the weighting may be carried out using task-specific uncertainty, based on an analytical optimum computation. In addition, updating of weights of the machine learning model 50, based on the weighted losses for the training of the machine learning model 50, may be provided as a fifth training step 105.

The invention may be based and built on known approaches such as that described, for example, in Kendall, Alex, Yarin Gal, and Roberto Cipolla, “Multi-task learning using uncertainty to weigh losses for scene geometry and semantics,” Proceedings of the IEEE Conference on Computer Vision and Pattern Recognition, 2018. This allows task-specific uncertainties to be used in order to compensate for tasks in various scales. For example, one task may be measured in millimeters and another task may be measured in meters, which may result in drastically different loss weightings, which may be compensated for according to embodiment variants of the invention. However, an initialization for all task weights is customarily a fixed constant, for example 1. This initialization may be improved according to embodiment variants of the invention, and may thus lead to greatly improved results in large, diverse multitask environments.

During the training, Kendall et al. (see above) use the following equation in order to compensate for T tasks:

$$L ( σ ) = {\sum }_{t}^{T} \frac{{L}_{t} ( {M}_{ϕ} ( x ) , y )}{2 {σ}_{t}^{2}} + log ( {σ}_{t} ) , \qquad ( 1 )$$

where Lₜ(M_{ϕ}(x),y) is the loss for the task t, based on the input x that is fed into a neural network M_{ϕ} in order to find the label y. The inverse task weights σₜ are scalar parameters that are learned (using gradient descent). Intuitively, σₜ→inf would be optimal in order to minimize the loss in the first term; however, this is avoided on account of the second term log(σₜ). Thus, all tasks are weighted with a compensated σₜ, which may be found using gradient descent. The exact form of the function may change, depending on the type of distribution assumed. In the present case a Gaussian distribution, i.e., an L₂-based regression task, is assumed.

The invention may advantageously be divided into multiple steps: estimating the task weights for the first samples, using a running average for weighting the tasks, and seamlessly transferring into uncertainty weighting methods, for example according to Kendall et al. (see above).

According to a first step, estimating the task weights for the first samples, during the training the following equation may be used to compensate for T tasks. For the sake of simplicity, in the following discussion the focus is placed on deriving the formulas for regression tasks. For the classification, the 2 in the denominator would be changed to a 1, for example:

$$L ( σ ) = {\sum }_{t}^{T} \frac{{L}_{t} ( {M}_{ϕ} ( x ) , y )}{2 {σ}_{t}^{2}} + log ( {σ}_{t} ) , \qquad ( 2 )$$

To estimate an optimal initialization for a series of training samples and the loss L(x, y), the initialization may be analytically computed based on the above equation. Since a sum is involved, this may be independently carried out for each σ_i. This results in:

$$\frac{\partial {L}_{t}}{\partial {σ}_{t}} = 0 \qquad ( 3 )$$

Solving for σₜ results in the following:

$${σ}_{t} = \sqrt{{L}_{t}} \qquad ( 4 )$$

Thus, in the first iteration (for example, based on the first image that is fed into a neural network, and the computation of the losses), which contains a loss for this specific task, the weights may be initialized using σₜ=\sqrt{Lₜ}.

In FIG. 2, equation 1 above is plotted for an individual loss L₀=1 with respect to the loss weight σₜ. It is apparent that the optimal solution is σₜ=√L₁=1.

This differs greatly from conventional solutions such as Kendall et al., which initialize σ_t using a constant and backpropagation (gradient descent) for the updating.

According to a further step, using a running average for weighting the tasks, for the subsequent training iterations i a running average may be computed over the loss weights of the present iteration and of the previous iterations:

$${σ}_{t , i} = \frac{i * {σ}_{t , i - 1} + \sqrt{{L}_{t , i}}}{i + 1} . \qquad ( 5 )$$

This may be carried out for the first pair of iterations. The exact number of first iterations N for which the analytical solution and the running average are used is a hyperparameter. In general, the method has empirically proven to be very robust with regard to this hyperparameter. As a general rule, the following applies: The greater the variance of the task-specific losses across samples, the larger the number of iterations that are to be used for estimating the initialization. From a technical standpoint, any value between 1 and the total number of training steps is possible. The actual network training may also be carried out beginning with the 0th iteration, since an estimation for the loss weight is present in the 0th iteration.

According to the next step, a seamless transfer into the methods of uncertainty weighting, for example by Kendall et al., may subsequently take place. After a predefined number of iterations that are used for the initialization, a change may be made to an update of the uncertainty weighting based on gradient descent, analogous to Kendall et al.

In the above explanation of the embodiments, the present invention is described solely in terms of examples. Of course, individual features of the embodiments, if technically feasible, may be freely combined with one another without departing from the scope of the present invention.

1. A method for training a machine learning model for application for a machine, comprising the following training steps:
providing training data, the training data being specific for the application of the machine learning model,
initiating processing of the training data, in which multiple tasks are processed by the machine learning model concurrently,
determining losses for the individual tasks, the particular loss being based on a difference between the output generated by the machine learning model and a default,
weighting the determined losses, the weighting being carried out using at least one task-specific uncertainty based on an analytical computation,
updating weights of the machine learning model, based on the weighted losses, for the training of the machine learning model.

2. The method according to claim 1,
characterized in that the step of updating the weights of the machine learning model is carried out initially at a start of the training and/or subsequently iteratively during the training, in each case based on the analytical optimum computation, wherein the losses are initially weighted differently, and an initialization of the weighting of loss functions for the losses for the various tasks and in particular an initialization of task weights preferably takes place differently.

3. The method according to claim 1,
characterized in that the losses for each of the tasks are determined based on a task-specific loss function, which is preferably based on a distribution of a location-scale family and approximations and/or maximization of a Gaussian probability with homoscedastic uncertainty, wherein the task-specific uncertainty is determined based on the loss that is determined for the particular task, wherein a representation or unit of the tasks differs, and wherein the task-specific uncertainty is a function of the representation or unit, and the step of weighting the determined losses is carried out based on the analytical optimum computation and/or the loss function of a present and/or previous iteration of the training steps.

4. The method according to claim 1, characterized in that the analytical optimum computation, in particular of a loss weight of a present iteration, is additionally stabilized with the loss weights of multiple previous iterations of the training steps, in particular by means of a running average.

5. The method according to claim 1, characterized in that the machine learning model is designed as an artificial neural multitasking network in order to concurrently process the multiple tasks for assisting with operation of the machine, preferably for providing autonomous driving.

6. The method according to claim 1, characterized in that the training data are specific for collected sensor data from at least one sensor, preferably a camera sensor, of the machine, preferably a vehicle, wherein the machine learning model is trained for the application for autonomous driving, in particular for pedestrian recognition and/or vehicle recognition and/or roadway recognition, wherein the tasks encompass semantic segmentation and/or object recognition and/or classification.

7. A machine learning model for assisting with operation of a machine via the processing of multiple tasks for the machine, trained by a method according to claim 1.

8. (canceled)

9. A device for data processing comprising:
a processor configured to execute a computer program to cause the processor to:
provide training data, the training data being specific for application of a machine learning model,
initiate processing of the training data, in which multiple tasks are processed by the machine learning model concurrently,
determine losses for the individual tasks, the particular loss being based on a difference between the output generated by the machine learning model and a default,
weight the determined losses, the weighting being carried out using at least one task-specific uncertainty based on an analytical computation,
update weights of the machine learning model, based on the weighted losses, for the training of the machine learning model.

10. A non-tangible computer-readable memory medium that includes commands which, when executed by a computer, cause the computer to:
provide training data, the training data being specific for application of a machine learning model,
initiate processing of the training data, in which multiple tasks are processed by the machine learning model concurrently,
determine losses for the individual tasks, the particular loss being based on a difference between the output generated by the machine learning model and a default,
weight the determined losses, the weighting being carried out using at least one task-specific uncertainty based on an analytical computation,
update weights of the machine learning model, based on the weighted losses, for the training of the machine learning model.
